(19) United States
(12) Patent Application Publication
(10) Pub. No.: US 2013/0133222 A1
(43) Pub. Date: May 30, 2013

(54) PARTICULATE FLUIDIZATION SYSTEM

(71) Applicants: Anand Kumar, Bangalore (IN); Satish Sambhaji Jadhav, Bangalore (IN)

(72) Inventors: Anand Kumar, Bangalore (IN); Satish Sambhaji Jadhav, Bangalore (IN)

(73) Assignee: General Electric Company, Schenectady, NY (US)

(21) Appl. No.: 13/308,455

(22) Filed: Nov. 30, 2011

(51) Int. Cl. F26B 17/00

(52) U.S. Cl. 34/579; 34/582; 34/585

(57) ABSTRACT

The disclosures described herein provide for an apparatus suitable for fluidizing fuel. In one embodiment, a system includes a fluidization vessel. The fluidization vessel includes a first inlet configured to receive a particulate fuel and a round chamber comprising a first aerator, wherein the round chamber is fluidly coupled to the first inlet and is configured to receive the particulate fuel. The system further includes a first outlet fluidly coupled to the round chamber and configured to convey a fluidized particulate fuel outwardly from the round chamber, wherein the first aerator is configured to discharge a first fluid into an interior of the round chamber to fluidize the particulate fuel into the fluidized fuel.

### BACKGROUND OF THE INVENTION

The subject matter disclosed herein relates to the fluidization of particles. More specifically, the disclosed embodiments relate to a system for fluidizing particles, such as carbonaceous fuel particles.

Granular material, such as coal, may be fluidized for use in the production of electricity, chemicals, synthetic fuels, or for a variety of other applications. Fluidization involves enabling the conversion of the granular material from a static, solid-like state into a dynamic, fluid-like state. For example, a fluid (e.g., liquid or gas) may be used to create the granular material fluid flow inside of a fluidization vessel. Different materials may be fluidized with varying success. That is, a minimum fluid flow velocity generally indicates that a material is behaving as a fluid, like a liquid or gas. However, the fluidization vessel may not be fluidizing the particles as efficiently as desired.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a fluidization vessel. The fluidization vessel includes a first inlet configured to receive a particulate fuel and a round chamber comprising a first aerator, wherein the round chamber is fluidly coupled to the first inlet and is configured to receive the particulate fuel. The system further includes a first outlet fluidly coupled to the round chamber and configured to convey a fluidized particulate fuel outwardly from the round chamber, wherein the first aerator is configured to discharge a first fluid into an interior of the round chamber to fluidize the particulate fuel into the fluidized fuel.

In a second embodiment, a system includes a fluidization vessel, including at least one sensor configured to obtain sensor feedback relating to at least one parameter and a round chamber a first inlet fluidly coupled to the round chamber, wherein the first inlet is configured to direct a particulate fuel into the round chamber. The fluidization vessel further includes an aerator disposed in the round chamber and a first outlet fluidly coupled to the round chamber, wherein the first outlet is configured to convey a fluidized particulate fuel outwardly from the round chamber. The system also includes a controller configured to control the aerator to discharge a fluid into the approximately round chamber to fluidize the particulate fuel into the fluidized particulate fuel based on sensor feedback.

In a third embodiment, a system includes at least one inlet configured to convey a particulate fuel from a particulate fuel supply and a corner-less chamber fluidly coupled to the at least one inlet. The system further includes at least one aerator disposed inside the corner-less chamber, and at least one outlet fluidly coupled to the corner-less chamber and configured to convey a fluidized particulate fuel outwardly from the corner-less chamber, wherein the at least one aerator is configured to discharge a fluid into the corner-less chamber to fluidize the particulate fuel into the fluidized particulate fuel.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an embodiment of an integrated gasification combined cycle (IGCC) power plant having a fluidization vessel;

FIG. 2 is a cross-sectional view of an embodiment of the fluidization vessel shown in FIG. 1, including an approximate spherical chamber;

FIG. 3 it a top view of an embodiment of a ring aerator taken through line 3-3 of FIG. 2;

FIG. 4. Is a top view of an embodiment of an arcuate aerator taken through line 4-4 of FIG. 2;

FIG. 5 is a cross-sectional view of an embodiment of the fluidization vessel of FIG. 1 including arcuate aerators;

FIG. 6 is a cross-sectional view of an embodiment of the fluidization vessel of FIG. 1 including two ring aerators and an arcuate aerator;

FIG. 7 is a cross-sectional view of an embodiment of the fluidization vessel of FIG. 1 including an approximately oval chamber; and

FIG. 8 is a flow chart of an embodiment of a process suitable for the fluidization of a fuel.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include a corner-less fluidization vessel suitable for fluidizing granular or particulate materials, including coal, grain, petroleum coke, and biomass (e.g., wood chips, husks, bagasses). Indeed, a wide variety of materials having granular or particulate matter may be fluidized using the embodiments described herein. The corner-less vessel may include a shape minimizing or eliminating concave corners. That is, the fluidization vessel shape described herein may eliminate interior angled corners (e.g., convex corners, concave corners). For example, the fluidization vessel shape may be an approximately round shape, such as a spherical shape, an oval shape, an ovoid shape (e.g., egg shape), or an elliptical shape suitable for more efficiently fluidizing material while eliminating fluidization “dead” zones, as described in more detail below. Further, the approximately round shape may reduce mechanical stresses (e.g., fluid pressure stresses) related to fluidization activities. Because of the inherent strength of the approximately round shape, the fluidization vessel may include walls of a lesser thickness than comparable volume fluidization vessels, reducing material cost and increasing manufacturing efficiencies. Additionally, the approximately round shape may have the smallest surface area for a volume and may contain the greatest volume for a fixed surface area.

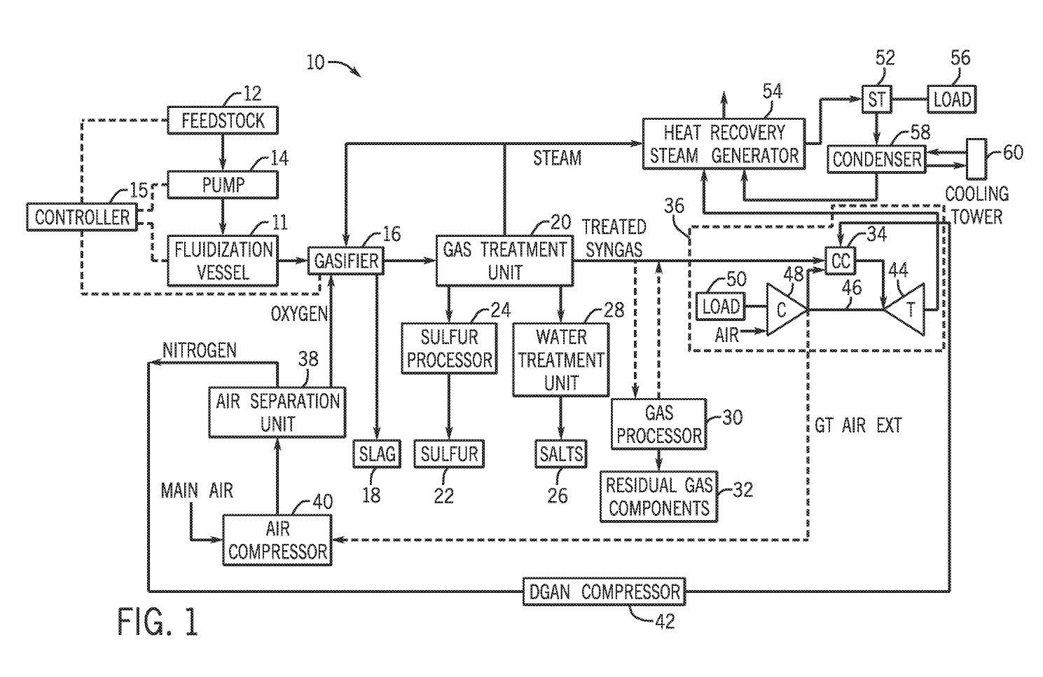

With the foregoing in mind, it may be beneficial to describe an embodiment of a fluidization vessel incorporating the techniques disclosed herein, that may be used, for example, in a power production plant. FIG. 1 is a diagram of an embodiment of an integrated gasification combined cycle (IGCC) system 10 that may include a fluidization vessel 11 having an approximately round shape (e.g., spherical, oval, or ellipsoid shape). Components of the IGCC system 10 may also include a feedstock delivery system 12 which may be used to deliver a fuel for the IGCC system 10. The feedstock delivery system 12 may deliver a particulate fuel such as coal, petroleum coke, biomass, tars, asphalt, or other carbon containing items. The fuel may be provided to a pump 14, such as a posimetric pump useful in pumping solids. The pump 14 may be driven by a controller 15 to move solids, such as the fuel provided by the feedstock delivery system 12, into the fluidization vessel 11. The controller 15 may also be used to control the fluidization of the delivered fuel by the fluidization vessel 11, and may then direct the fluidization vessel 11 to provide fluidized fuel to a gasifier 16.

The gasifier 16 may convert the fluidized fuel into syngas, e.g., a combination of carbon monoxide and hydrogen. This conversion may be accomplished by subjecting the non-aqueous slurry to a controlled amount of steam and oxygen at elevated pressures (e.g., from approximately 600 psi-1200 psi) and temperatures (e.g., approximately 2200° F.-2700° F.), depending on the type of gasifier 16 utilized. The heating of the non-aqueous slurry during a pyrolysis process may generate a solid (e.g., char) and residue gases (e.g., carbon monoxide, hydrogen, and nitrogen). The char remaining from the non-aqueous slurry from the pyrolysis process may only weigh up to approximately 30% of the weight of the original feedstocks.

The combustion reaction in the gasifier 16 may include introducing oxygen to the char and residue gases. The char and residue gases may react with the oxygen to form carbon dioxide and carbon monoxide, which provides heat for the subsequent gasification reactions. The temperatures during the combustion process may range from approximately 2200° F. to approximately 2700° F. In addition, steam may be introduced into the gasifier 16. In essence, the gasifier utilizes steam and oxygen to allow some of the non-aqueous slurry to be burned to produce carbon monoxide and energy, which may drive a second reaction that converts further feedstock to hydrogen and additional carbon dioxide.

In this way, a resultant gas may be manufactured by the gasifier 16. The resultant gas may include approximately 85% of carbon monoxide and hydrogen, as well as CH₄, HCl, HF, COS, NH₃, HCN, and H₂S (based on the sulfur content of the feedstock). This resultant gas may be termed “untreated syngas.” The gasifier 16 may also generate waste, such as slag 18, which may be a wet ash material. As described in greater detail below, a gas treatment unit 20 may be utilized to treat the untreated syngas. The gas treatment unit 20 may scrub the untreated syngas to remove the HCl, HF, COS, HCN, and H₂S from the untreated syngas, which may include separation of sulfur 22 in a sulfur processor 24 by, for example, an acid gas removal process in the sulfur processor 24. Furthermore, the gas treatment unit 20 may separate salts 26 from the untreated syngas via a water treatment unit 28, which may utilize water purification techniques to generate usable salts 26 from the untreated syngas. Subsequently, a treated syngas may be generated from the gas treatment unit 20.

A gas processor 30 may be utilized to remove residual gas components 32 from the treated syngas, such as ammonia and methane, as well as methanol or other residual chemicals. However, removal of residual gas components 32 from the treated syngas is optional since the treated syngas may be utilized as a fuel even when containing the residual gas components 32 (e.g., tail gas). At this point, the treated syngas may include approximately 3% CO, approximately 55% H₂, and approximately 40% CO₂, and may be substantially stripped of H₂S. This treated syngas may be directed into a combustor 36 (e.g., a combustion chamber) of a gas turbine engine 36 as combustible fuel.

The IGCC system 10 may further include an air separation unit (ASU) 38. The ASU 38 may separate air into component gases using, for example, distillation techniques. The ASU 38 may separate oxygen from the air supplied to it from a supplemental air compressor 40 and may transfer the separated oxygen to the gasifier 16. Additionally, the ASU 38 may direct separated nitrogen to a diluent nitrogen (DGAN) compressor 43. The DGAN compressor 42 may compress the nitrogen received from the ASU 38 at least to pressure levels equal to those in the combustor 34, so as to not interfere with proper combustion of the syngas. Thus, once the DGAN compressor 42 has adequately compressed the nitrogen to an adequate level, the DGAN compressor 42 may direct the compressed nitrogen to the combustor 34 of the gas turbine engine 36.

As described above, the compressed nitrogen may be transferred from the DGAN compressor 42 to the combustor 34 of the gas turbine engine 36. The gas turbine engine 36 may include a turbine 44, a drive shaft 46, and a compressor 48, as well as the combustor 34. The combustor 34 may receive fuel, such as the syngas, which may be injected under pressure from fuel nozzles. This fuel may be mixed with compressed air as well as compressed nitrogen from the DGAN compressor 42 and combusted within the combustor 34. This combustion may create hot pressurized exhaust gases.

The combustor 34 may direct the exhaust gases towards an exhaust outlet of the turbine 44. As the exhaust gases from the combustor 34 pass through the turbine 44, the exhaust gases may force turbine blades in the turbine 44 to rotate the drive shaft 46 along an axis of the gas turbine engine 36. As illustrated, the drive shaft 46 may be connected to various components of the gas turbine engine 36, including a compressor 48.

The drive shaft 46 may connect the turbine 44 to the compressor 48 to form a rotor. The compressor 48 may include blades coupled to the drive shaft 46. Thus, rotation of turbine blades in the turbine 44 may cause the drive shaft 46 connecting the turbine 44 to the compressor 48 to rotate blades within the compressor 48. The rotation of blades in the compressor 48 causes the compressor 48 to compress air received via an air intake in the compressor 48. The compressed air may then be fed to the combustor 34 and mixed with fuel and compressed nitrogen to allow for higher efficiency combustion. The drive shaft 46 may also be connected to a load 50, which may be a stationary load, such as an electrical generator, for producing electrical power in a power plant. Indeed, the load 50 may be any suitable device that is powered by the rotational output of the gas turbine engine 36.

The IGCC system 10 also may include a steam turbine engine 52 and a heat recovery steam generation (HRSG) system 54. The steam turbine engine 52 may drive a second load 56, such as an electrical generator for generating electrical power. However, both the first and second loads 50, 56 may be other types of loads capable of being driven by the gas turbine engine 36 and the steam turbine engine 52, respectively. In addition, although the gas turbine engine 36 and the steam turbine engine 52 may drive separate loads 50, 56, as shown in the illustrated embodiment, the gas turbine engine 36 and the steam turbine engine 52 may also be utilized in tandem to drive a single load via a single shaft. The specific configuration of the steam turbine engine 52, as well as the gas turbine engine 36, may be implementation-specific and may include any combination of sections.

Heated exhaust gas from the gas turbine engine 36 may be directed into the HRSG 54 and used to heat water and produce steam used to power the steam turbine engine 52. Exhaust from the steam turbine engine 52 may be directed into a condenser 58. The condenser 58 may utilize a cooling tower 60 to exchange heated water for chilled water. In particular, the cooling tower 60 may provide cool water to the condenser 58 to aid in condensing the steam directed into the condenser 58 from the steam turbine engine 52. Condensate from the condenser 58 may, in turn, be directed into the HRSG 54. Again, exhaust from the gas turbine engine 36 may also be directed into the HRSG 54 to heat the water from the condenser 58 and produce steam.

As such, in combined cycle systems such as the IGCC system 10, hot exhaust may flow from the gas turbine engine 36 to the HRSG 54, where it may be used to generate high-pressure, high-temperature steam. The steam produced by the HRSG 54 may then be passed through the steam turbine engine 52 for power generation. In addition, the produced steam may also be supplied to any other processes where steam may be used, such as to the gasifier 16. The gas turbine engine 36 generation cycle is often referred to as the “topping cycle,” whereas the steam turbine engine 52 generation cycle is often referred to as the “bottoming cycle.” By combining these two cycles as illustrated in FIG. 1, the IGCC system 10 may lead to greater efficiencies in both cycles. In particular, exhaust heat from the topping cycle may be captured and used to generate steam for use in the bottoming cycle.

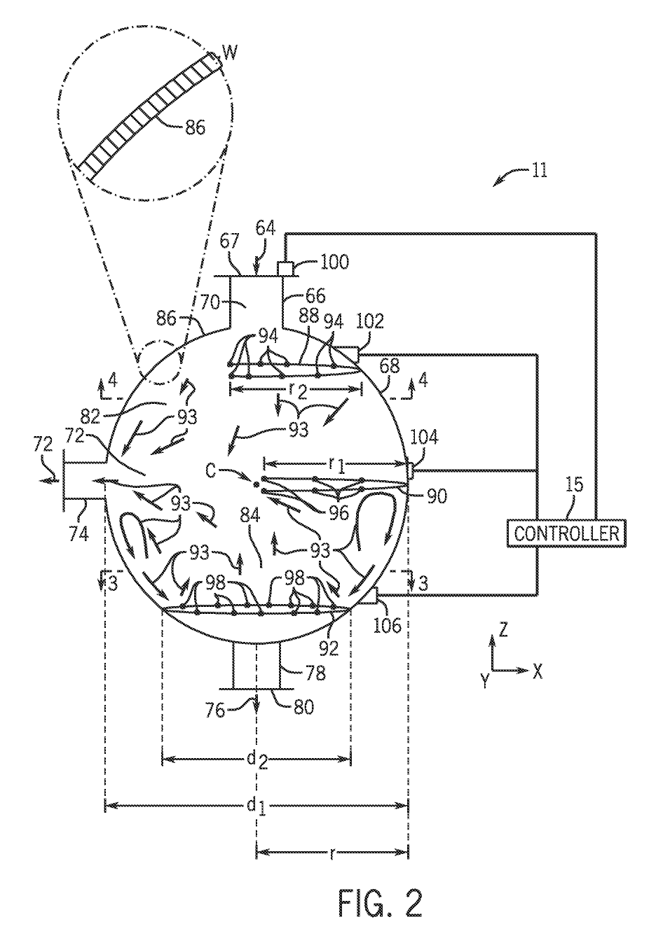

Turning to FIG. 2, an embodiment of the fluidization vessel 11 is depicted in cross-section. In the illustrated embodiment, fuel 64 (e.g., a carbonaceous particulate fuel) may enter through an inlet 66 having an opening 67 into a chamber 68, change states from a solid-like state 70 into a fluid-like state 72, and exit the chamber 68 through an outlet 74. It is to be understood that, in other embodiments, multiple inlets 66 may be provided. Residual fuel 76 may fall through a maintenance outlet 78 having an opening 80, for example, for subsequent reuse. It is to be understood that, in other embodiments, multiple maintenance outlets 78 may be provided. By fluidizing the fuel 64, the fluidization vessel 11 may enable a more efficient, faster transport of the fuel 64, using, for example, conduits or pipes rather than conveyor belts. In the depicted embodiment, the chamber 68 includes an approximately spherical shape with a radius r and a diameter d₁=2r. For example, the spherical shape may be approximately defined by the equation r²=(x−xₒ)²+(y−yₒ)²+(z−zₒ)² where the chamber 68 has a center point C. The spherical chamber 68 may be divided into two halves, an upper hemisphere 82 and a lower hemisphere 84.

The spherical chamber 68 may enable a more efficient fluidization of the fuel 64. For example, the spherical chamber 68 may eliminate “dead” zones of pooled or slow moving fuel caused by concave or convex angles found inside other chambers having conical and/or rectangular shapes. Indeed, the spherical chamber 68 is a corner-less chamber lacking sudden changes in angles, thus providing for a smooth surface suitable for eliminating “dead” zones and improving the movement, homogeneous mixing, and subsequent fluidization of the fuel 64. For example, the spherical chamber 68 may have an interior angle that does not change more than approximately between 0.5% to 1%, 1% to 5%, 5% to 10% of the circumference of the chamber 68. Likewise, no curved corner would have a radius less than approximately 50% of the radius of the chamber. Further, the spherical chamber 68 eliminates high velocity impingement of particles against corners, thus reducing wear. Wall tension, e.g., the adherence of some fuel particles to walls 86 of the spherical chamber 68 is also reduced, resulting in more efficient fluidization. The walls 86 may have a thickness w, as depicted. Because of the spherical shape of the chamber 68, the wall's thickness w may be smaller than other chambers containing the same amount of internal volume, such as square, conical, and cylindrical chambers. Accordingly, less material may be used to manufacture the spherical chamber 68 when compared to other chambers having similar containment volumes, leading to improved manufacturing efficiencies and reduced cost.

In one embodiment, the thickness w may be derived by using the American Society for Mechanical Engineers (ASME) recommendations for pressurized spherical containers, such as the equation w=fPr/2SE where P is an internal pressure of the fluidized fuel 72, r is the aforementioned radius of the spherical chamber 68, S is a tensile strength of a material (e.g., steel, carbon steel, steel alloy, cro-moly, aluminum) used to construct the walls 86, and f is a safety factor selected by a design engineer, typically greater than 1. It is to be understood that, in other embodiments, the thickness w may be derived by using other recommendations for pressurizes spherical containers, such as the pressure equipment directives (PED) of the European Union, and/or the Dutch Rules for pressure vessels.

The fluidization vessel 11 may also include a plurality of aerators 88, 90, and 92. The aerators 88, 90, and 92 may provide for a flow of a fluid (i.e., liquid or gas), such as air, nitrogen, oxygen, and/or water, into the chamber 68. The flow of fluid may impinge upon the fuel 64, separating the packed particles of the fuel 64 and propelling the fuel particles in desired directions 93 (e.g., shown as arrows 93 disposed inside the chamber 68), resulting in the fluidization of the fuel 64. It is to be understood that the fluidization vessel 11 may enable both particulate fluidization as well as bubbling fluidization. In particulate fluidization, the flow of fuel 64 may be a liquid flow, resulting in an average fluidization density in most sections of the chamber 68. In bubbling fluidization, the flow may be a gaseous flow of fuel 64, resulting in pockets of gas free of particles moving through the chamber 68.

Depending on the type of fluidization (e.g., particulate fluidization, bubbling fluidization) desired, Ergun's equation described below may be used to derive a minimum fluidization velocity uₘ.

Ergun's Equation:

$$g ( {p}_{s} - p ) = \frac{1.75 {pu}_{m}^{2}}{{d}_{p} {ɛ}^{3}} + \frac{150 μ ( 1 - ɛ ) {u}_{m}^{2}}{{d}_{p}^{2} {ɛ}^{3}}$$

Where g is acceleration to due to gravity, p is the density of the fluid used to fluidize the fuel 64, pₛ is a catalyst density, dₚ is a fuel 64 particle diameter, ε is a void space in the chamber 68, and μ is the viscosity of the fluid output by the aerators 88, 90, and 92. Each aerator 88, 90, and 92 may include a plurality of nozzles 94, 96, and 98 useful in directing the fluid provided by the aerators 88, 90, and 92, respectively, into the chamber 68. In one embodiment, each of the aerators 88, 90, and 92 may be a pipe or a conduit including openings 94, 96, and 98, respectively. In the depicted embodiment, the aerator 88 may be disposed in the upper hemisphere 82 of the spherical chamber 68, the aerator 90 may be disposed in the approximately between the upper hemisphere 82 and the lower hemisphere 84 of the spherical chamber 68, and the aerator 92 may be disposed in the lower hemisphere 84. By directing a fluid flow into the chamber 68, the aerators 88, 90, and 92 may provide the minimum fluidization velocity uₘ suitable for fluidizing the fuel 64.

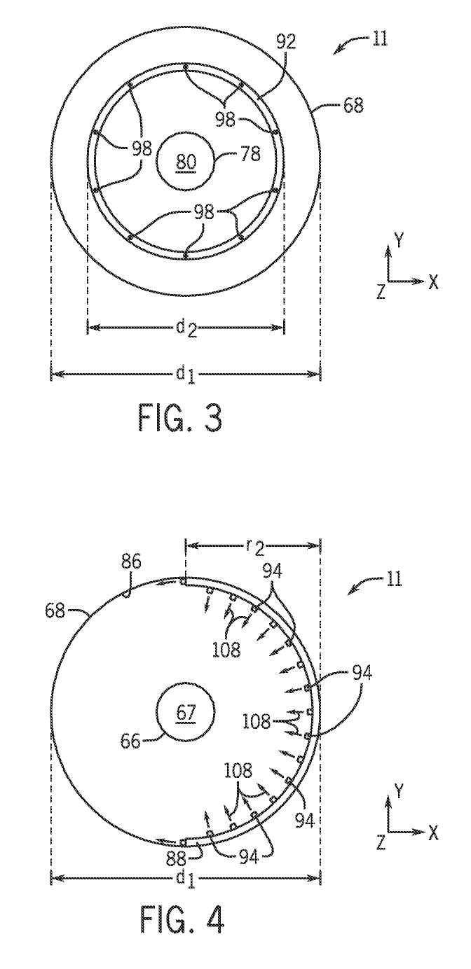

For example, the aerator 92 may be provided as a ring having a diameter d₂ and disposed circumferentially inside of the chamber 68, as described in more detail below with respect to FIG. 3. In one embodiment, the nozzles 98 may be provided as evenly spaced openings in the ring aerator 92. For example, the ring aerator may be a pipe or conduit including evenly spaced openings 98. Such nozzle openings 98 may be generally pointed away from the maintenance outlet 78 and towards the upper hemisphere 82. Accordingly, the flow of fluid (e.g., gas or liquid) exiting from the aerator 92 may impinge the fuel 64 entering the chamber 68 through the inlet 66. Likewise, the aerator 90 may be provided as a partial ring or arc having a radius r₁ and also circumferentially disposed inside of the chamber 68 approximately between the upper and lower hemispheres 82, 84, as described in more detail below with respect to FIG. 4. The aerator 90 may provide for additional fluid flow, including fluid flow generally directed towards the center point C suitable for directing particulate matter outwardly through the outlet 74. It is to be understood that, in other embodiments, multiple outlets 74 may be provided. Additional fluid flow may also be provided by the aerator 88. In the depicted embodiment, the aerator 88 is provided as a partial ring or arc having a radius r₂ and circumferentially disposed in the upper hemisphere 82 of the chamber 68, and approximately near the inlet 66. By disposing the aerator 88 proximate to the inlet 66, the aerator 88 may provide for the additional fluid flow, including a fluid flow directing the fuel 64 into the chamber 68. By providing for multiple aerators 88, 90, and 92, the fluidization vessel 11 may more homogenously mix the fuel 64 and enable the minimum fluidization velocity uₘ suitable for fluidizing the fuel 64, resulting in fluidized fuel 72.

In one example, the controller 15 may be used to control the fluid exiting the aerators 88, 90, and 92, including the exit flow rate and flow velocity. Additionally, the controller 15 may be communicatively connected to sensors 100, 102, 104, and 106, suitable for sensing delivery of the fuel 64 and subsequent fluidization of the fuel 64. In one embodiment, the sensor 100 may sense incoming fuel 64, and the sensors 102, 104, and 106 may sense fluidization of the fuel 64. Each of the sensors 100, 102, 104, and 106 may be an acoustic sensor, an optical sensor, a capacitance sensor, a conductivity sensor, or a combination thereof, suitable for detecting particulate matter. The detected particulate information may include, for example, particulate density (e.g., clusters), particulate count, particulate velocity, and/or particulate dispersal. By detecting and responding to particulate information, the controller 15 may more efficiently adjust the fluid flow exiting the aerators 88, 90, and 92, for example, by increasing or decreasing flow rates and/or flow velocities. In this manner, the controller 15 may provide for a suitable fluid flow exiting the aerators and enabling a more efficient fluidization of the fuel 64.

FIG. 3 is a cross sectional top view of an embodiment of the ring or arcuate aerator 92 and an arrangement of the nozzles 98 taken through line 3-3 of FIG. 2. As mentioned above, the ring aerator 92 may include the diameter d₂ smaller than the chamber 68 diameter d₁. Accordingly, the ring aerator 92 may be disposed in the interior of the chamber 68. Also depicted is the opening 80 of the outlet 78. The outlet 78 may include a valve suitable for opening and closing the opening 80. In one embodiment, the opening 80 may be opened at a scheduled time (e.g., every second, every minute, every hour) to remove any fuel 64 that may have fallen into the outlet 78. In another embodiment, the opening 80 may be opened by sensing the fuel level of fuel 64 collected in the outlet 78. The fuel 64 may then be removed and reused in subsequent fluidization operations. In the depicted embodiment, the nozzles 98 are arranged approximately equidistant to each other. For example, the aerator 88 may be a pipe or a conduit having openings or holes 98. The equidistant placement of the nozzles 98 may enable a more even and uniform fluid flow exiting the aerator 92. In other embodiments, the nozzles 98 may not be equidistant. Indeed, in another embodiment, an aerator may be provided as a partial ring or arc, so as to provide for a more directional fluid flow, as described in more detail below with respect to FIG. 4.

FIG. 4 is a cross sectional top view of and embodiment of the arcuate aerator 88 having a partial ring or arc shape taken through line 4-4 of FIG. 2. The arc shape of the arcuate aerator 88 may advantageously provide for a fluid flow in a more directional manner, such as inward radial direction 108. That is, in addition to aiding in the fluidization of the fuel 64, the aerator 88 may aid in directing the flow of fuel 64 towards the outlet 74 shown in FIG. 2, thus enabling the movement of the fluidized fuel 72 outwardly from the spherical chamber 68. The arcuate aerator 88 is depicted as having the radius r₂. Longer radii r₂ may improve fluidization in the chamber 68 side opposite the arcuate aerator 88. Likewise, shorter radii r₂ may improve fluidization in chamber 68 portions proximate to the arcuate aerator 88. In the depicted embodiment, the radius r₂ is approximately ½ the diameter d₁ of the spherical chamber 68.

In the illustrated embodiment, the nozzles 94 are depicted as protruding nozzles 94. Other embodiments, may include non-protruding nozzles (e.g., openings or holes in the aerator 88), or a combination of non-protruding and protruding nozzles 94. Additionally, in the depicted embodiment, the nozzles 94 are arranged equidistant to each other. In other embodiments, the nozzles 94 may be non-equidistant to each other. Further, the nozzles 94 may be coupled to actuators suitable for moving the nozzles 94 during fuel fluidization operations. Indeed, in one embodiment, the nozzles 94 may be directionally controlled during fluidization operations so as to minimize or eliminate fuel pooling in the spherical chamber 68. Further, all embodiments of the aerators described herein may include protruding nozzles, non protruding nozzles, and/or directional nozzles under active control.

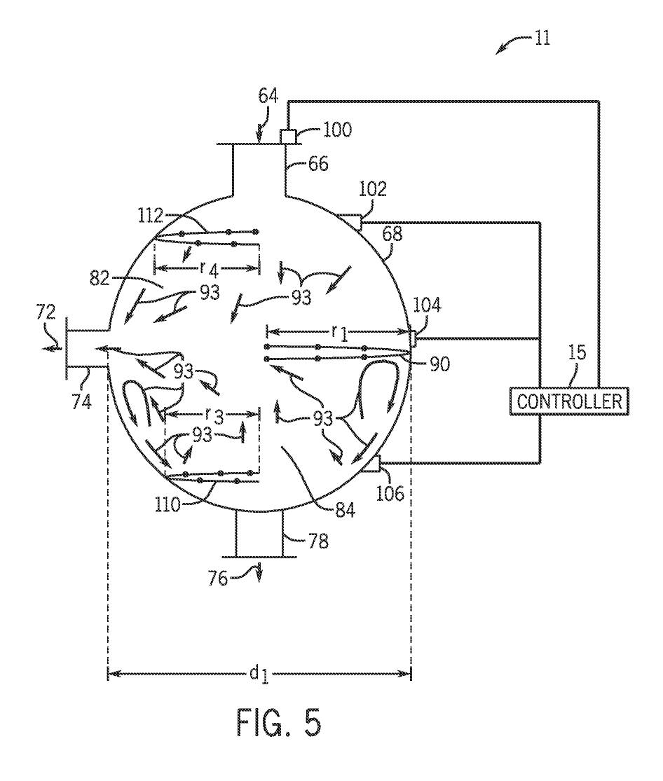

The opening 67 of the inlet 66 is also depicted. As mentioned above, the fuel 64 that may descend through the opening 67 into the spherical chamber 68. The arcuate aerator 88 is also depicted as circumferentially abutting the walls 86 of the chamber 68. By abutting the walls 86 of the chamber 68, fluidization of the fuel 64 may be improved by exposing more fuel 64 to fluid exiting the aerator 88. In another embodiment, the arcuate aerator 88 may not abut the walls 86 of the chamber 68. Further, more than one arcuate aerator 88 may be provided, as described in more detail below with respect to FIG. 5.

FIG. 5 depicts an embodiment of the fluidization vessel 11 including three arcuate aerators 90, 110, and 112. Because the figure includes like elements found in FIG. 2, these elements are denoted using like reference numbers. As mentioned above, the use of the arcuate aerators 90, 110, and 112 may improve directional control of the fluid flow inside of the chamber 68, in addition to providing for suitable fluid flow (e.g., gas or liquid) for fluidizing the fuel 64. For example, denser or heavier particulate matter may benefit from using the directional control to move the particles as desired. Likewise, a less-dense, lighter particulate matter may be fluidized more quickly, and the improved directional control may enhance entry through the inlet 66 and exit through the outlet 74. In the depicted embodiment, the upper arcuate aerator 112 may be placed on the upper hemisphere 82, as depicted, to improve fluidization proximate to the inlet 66. The lower aerator 110 includes a radius r₃. Longer radii r₃ may result in increased fluid flow within the chamber 68 side opposite to the arcuate aerator 110, while shorter radii r₃ may result in improved fluidization more in chamber 69 portions proximate to the arcuate aerator 110. Likewise, the upper arcuate aerator 112 includes a radius r₄. Longer radii r₄ may result in increased fluid flow within the chamber 68 side opposite to the arcuate aerator 112, while shorter radii r₄ may result in improved fluidization more in chamber 69 portions proximate to the arcuate aerator 112.

The arcuate aerator 90 is also depicted. As mentioned above with respect to FIG. 4, the aerator 90 may aid in directing the fluidized fuel 64 outwardly from the chamber 68 through the outlet 74. Additionally, the arcuate aerator 90 provides a fluid flow that may combine with the fluid flows provided by the arcuate aerators 110 and 112 to fluidize of the fuel 64. The fluid flows provided by the arcuate aerators 90, 110, and 112 may be controlled by the controller 15. As mentioned above with respect to FIG. 2, the controller 15 may use the sensors 100, 102, 104, and 106 to detect and direct fluidization activities. For example, particulate density (e.g., clusters), particulate count, particulate velocity, and/or particulate dispersal, may be sensed by the sensors 100, 102, 104, and 106 and communicated to the controller 15. The controller may then adjust fluid flows for each of the aerators 90, 110, and 112 accordingly. By detecting and responding to particulate information, the controller 15 may more efficiently adjust the fluid flows provided by the aerators 90, 110, and 112, for example, by increasing or decreasing fluid flow rates.

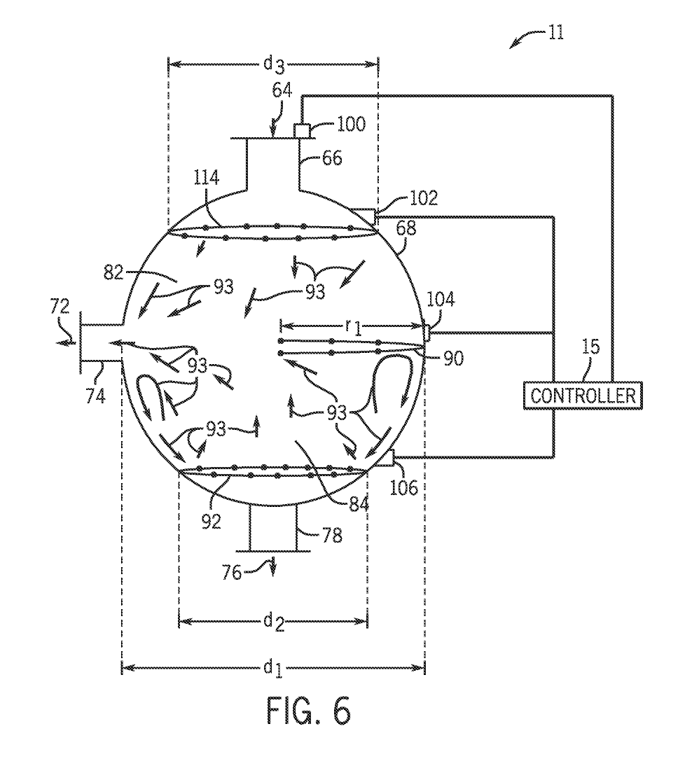

FIG. 6 depicts an embodiment of the fluidization vessel 11 including two ring aerators 92, 114, and the arcuate aerator 90. Because the figure includes like elements found in FIG. 2, these elements are denoted using like reference numbers. While the depicted embodiment of the fluidization vessel 11 includes the two ring aerators 92 and 114 combined with the arcuate aerator 90, other embodiments may include other combinations of ring and/or arcuate aerators. Indeed, in certain embodiments, only ring aerators may be included, while in other embodiments, only arcuate aerators may be included (e.g., the embodiment of FIG. 5). By combining the ring aerators 92 and 114 with the arcuate aerator 90, the fluidization vessel 11 may improve fluidization of the fuel 64. For example, certain lighter or less dense particulate fuel 64 may fluidize more easily by using the depicted combination of aerators 90, 92, and 114. By disposing the upper ring aerator 114 on the upper hemisphere 82, the fuel may move inwardly into the spherical chamber 68 more quickly and be subsequently fluidized more efficiently. The arcuate aerator 90 may then aid in directionally flowing of the fluidized fuel 72 outwardly through the outlet 72. The lower ring aerator 92 may also be used to provide fluid flow generally directed towards the upper hemisphere 82 of the spherical chamber 68. By combining the fluid flows from the upper ring aerator 114, the arcuate aerator 90, and the lower ring aerator 92, a more efficient fluidization of the fuel 64 may be provided.

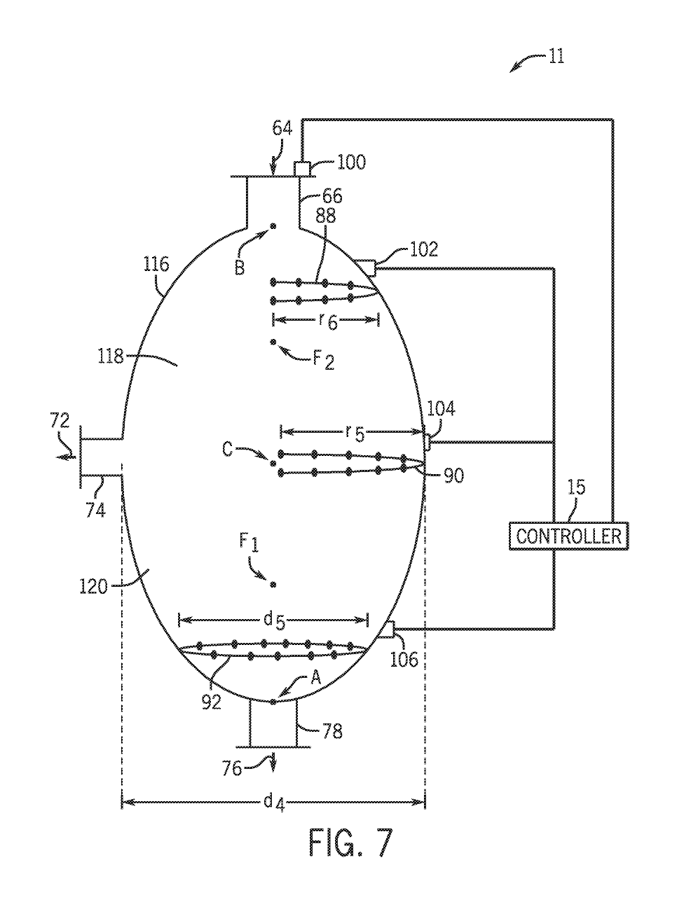

In the depicted embodiment, the upper ring aerator 114 includes a diameter d₃, while the lower ring aerator 91 includes the diameter d₂. In one embodiment, d₃ is approximately equal to d₁. In this embodiment, approximately equal fluid flows may be provided by the aerators 92 and 114. In another embodiment, the diameter d₃ of the upper ring aerator 114 may be smaller than the diameter d₂ of the lower ring aerator 92. In this embodiment, the lower ring aerator 92 may provide for greater gas flow when compared to the gas flow provided by the upper ring aerator 114. Accordingly, heavier or denser particles may be more easily fluidized by encountering higher gas flow incoming from the lower hemisphere 84 of the chamber 68. In yet another embodiment, the diameter d₃ of the upper ring aerator 114 may be greater than the diameter d₂ of the lower ring aerator 92. In this embodiment, the upper ring aerator 114 may provide for a greater gas flow when compared to the gas flow provided by the lower ring aerator 92. Consequently, lighter or less dense particles suitable for faster fluidization may be more efficiently moved through the inlet into the chamber 68, become fluidized, and be subsequently directed into the outlet 74. By providing for different types of aerators (e.g., ring aerators 92, 114, arcuate aerator 90) and aerator sizes, the fluidization systems and methods described herein may more efficiently fluidize a wider variety of fuel types. Additionally, chamber 68 may be provided in different shapes and sizes, as described in more detail below with respect to FIG. 7.

FIG. 7 is illustrative of an embodiment of the fluidization vessel 11 having an approximately oval-shaped chamber 116. The fluidization vessel 11 may be provided with chambers in various corner-less shapes, including the depicted oval-shape chamber 116, ovoid (e.g., egg-shaped chambers) shapes, elliptical shapes, and more generally, rounded shapes. In the depicted embodiment, the oval chamber's shape may be approximately defined by the polar equation

$$r ( θ ) = \frac{A B}{\sqrt{{( B cos θ )}^{2} + {( A sin θ )}^{2}}}$$

where the chamber 116 has a center point C, foci F₁ and F₂, endpoints A, B, and θ is the angular coordinate measured from the center point C. The oval chamber 116 may be divided into an upper hemisphere 118 and a lower hemisphere 120.

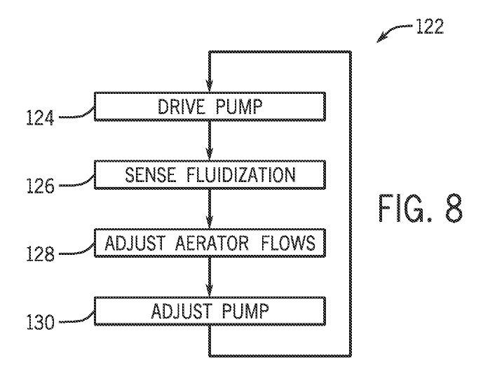

By lacking convex and concave angles, the oval chamber 116 provides for a corner-less shape suitable for minimizing or eliminating the pooling of the fuel 64. Accordingly, the fuel 64 may enter the oval chamber 116 through the inlet 66, encounter a fluid flow, such as a fluid flow provided fluidized particulate fuel by the arcuate aerators 88, 90 and ring aerator 92, and enter a fluidized phase. The fluidized fuel 64 may then exit the oval chamber 116 through the outlet 74 as fluidized fuel 72. Some of the fuel 64 may fall though the maintenance outlet 78 and reuse in later operations as residual fuel 76. While the depicted embodiment illustrates the use of the two arcuate aerators 88 and 90 and the single ring aerator 92, other embodiments may include other combination of aerators, including combinations using single arcuate aerator(s) and single ring or oval aerator(s). Indeed, in certain embodiments, only a single aerator (e.g., ring, oval or arcuate) may be used in all of the chambers 68 and 116 described herein. By providing for multiple corner-less chambers, including the oval shaped chamber 116, the systems and methods disclosed herein may enable a more efficient fluidization of particulate fuel 64. The depicted embodiment also shows the controller 15 communicatively coupled to the sensors 100, 102, 104, and 106 used to control fluidization activities. For example, the controller may use a process, as described in more detail with respect to FIG. 8, to enable the fluidization of the particulate fuel 64.

FIG. 8 illustrates an embodiment of a process 122 that may be used to fluidize particulate fuel. The process 122 may include instructions or computer code executable by a computing device such as the controller 15, a desktop computer, a laptop computer, a tablet computer, and a cell phone. In the depicted example, the process 122 may drive a pump (block 124), such as the pump 14 shown in FIG. 1, to deliver the fuel 64 into the fluidization vessel 11. For example, the pump 14 may be driven at a certain pumping capacity suitable for moving particulate matter through the outlet 66 and into the chamber 68 or 116. The process 122 may then sense fluidization (block 126). In one embodiment, the sensors 100, 102, 104, and 106 shown in FIGS. 2, 5, 6 and 7 may be used to derive fluidization measurements (e.g.,) as described above, suitable for sensing the fluidization (block 126). The process 122 may then adjust aerator fluid flow (block 128). For example, if fluidization is not occurring as rapidly as may be desired, then the process 122 may increase the flow of fluid (e.g., gas or liquid) through some or all of the aerators 88, 90, 92, 110, 112, and 114. In one example, aerators located more proximate to regions in the chambers 68 and 116 that may be sensed as experiencing too little fluidization may be directed to increase their fluid flows. Likewise, aerators located more proximate to regions of the chambers 68 and 116 that may be sensed to be experiencing too much fluidization may be directed to decrease their fluid flows. By adjusting the aerator fluid flows (block 128), the process may more efficiently fluidize the fuel 64.

The process 122 may additionally or alternatively adjust the pump 14 (block 130). For example, the pump 14 may be adjusted to deliver increased fuel 64 flow if the fuel 64 fluidization is under capacity. That is, if it is determined that the fluidization vessel 11 is operating under desired capacity, then the pump 14 may be adjusted to operate at increased fuel 64 delivery rates. Likewise, if it is determined that the fluidization vessel 11 is operating over desired capacity, then the pump 14 may be adjusted to operate at decreased fuel 64 delivery rates. By adjusting the pump 14 and/or the flow rates provided by the aerators 88, 90, 92, 110, 112, and 114, the process 122 may optimize the amount of fuel 64 fluidization and minimize energy expenditure (e.g., electrical expenditure), as well as wear and tear of equipment. The process 122 may then iterate to block 124 and continue process 122 execution.

Technical effects of the invention include providing a corner-less fluidization vessel (e.g., vessel including a chamber lacking concave and convex angles) suitable for fluidizing granular or particulate materials, including coal, grain, petroleum coke, and biomass (e.g., wood chips, husks, bagasses). In certain embodiment, the corner-less fluidization vessel may include an approximately round shape. The fluidization vessel may more efficiently fluidize the particulate fuel while minimizing or eliminating fluidization “dead” zones (e.g., no or low velocity zones) or pooled fuel. Further, the approximately round shape may reduce mechanical stresses (e.g., fluid pressure stresses) related to fluidization activities. Because of the inherent strength of the approximately round shape, the fluidization vessel may include walls of a lesser thickness than comparable volume fluidization vessels, reducing material cost and increasing manufacturing production. Additionally, the approximately round shape may have the smallest surface area for a volume and may contain the greatest volume for a fixed surface area.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a fluidization vessel comprising:
a first inlet configured to receive a particulate fuel;
a round chamber comprising a first aerator, wherein the round chamber is fluidly coupled to the first inlet and is configured to receive the particulate fuel; and
a first outlet fluidly coupled to the round chamber and configured to convey a fluidized particulate fuel outwardly from the round chamber, wherein the first aerator is configured to discharge a first fluid into an interior of the round chamber to fluidize the particulate fuel into the fluidized particulate fuel.

2. The system of claim 1, wherein the round chamber comprises a spherical chamber.

3. The system of claim 1, wherein the round chamber comprises an oval chamber.

4. The system of claim 3, wherein the round chamber comprises an elliptical chamber.

5. The system of claim 1, wherein the first aerator comprises a conduit having at least one nozzle configured to discharge the first fluid.

6. The system of claim 5, wherein the conduit comprises an approximately ring-shaped pipe having a plurality of nozzles circumferentially disposed inside the round chamber.

7. The system of claim 5, wherein the conduit comprises an arcuate pipe having a plurality of nozzles circumferentially disposed along an arc inside the round chamber.

8. The system of claim 1, wherein the first aerator is disposed on an upper hemisphere of the round chamber.

9. The system of claim 1, wherein the first aerator is disposed on a lower hemisphere of the round chamber.

10. The system of claim 1, wherein the first aerator is disposed approximately between an upper hemisphere and a lower hemisphere of the round chamber.

11. The system of claim 1, comprising a second aerator, wherein the second aerator is configured to discharge a second fluid into the round chamber to fluidize the particulate fuel into the fluidized particulate fuel.

12. The system of claim 1, comprising a second inlet fluidly coupled to the round chamber, wherein the first inlet and the second inlet are configured to convey the particulate fuel.

13. The system of claim 1, comprising a maintenance outlet fluidly coupled to a lower hemisphere of the approximately round chamber, wherein the maintenance outlet is configured to convey a residual fuel outwardly from the round chamber.

14. The system of claim 1, comprising a feedstock system and a pump upstream of the fluidization vessel and a gasifier downstream of the fluidization vessel, wherein the pump is configured to provide the particulate fuel from the feedstock system to the first inlet, and the outlet is configured to provide the fluidized particulate fuel to the gasifier.

15. A system comprising:
a fluidization vessel, comprising:
at least one sensor configured to obtain sensor feedback relating to at least one parameter;
a round chamber a first inlet fluidly coupled to the round chamber, wherein the first inlet is configured to direct a particulate fuel into the round chamber;
an aerator disposed in the round chamber;
a first outlet fluidly coupled to the round chamber, wherein the first outlet is configured to convey a fluidized particulate fuel outwardly from the round chamber; and
a controller configured to control the aerator to discharge a fluid into the approximately round chamber to fluidize the particulate fuel into the fluidized particulate fuel based on sensor feedback.

16. The system of claim 15, comprising at least one sensor, wherein the at least one sensor comprises an acoustic sensor, an optical sensor, a capacitance sensor, a conductivity sensor, or a combination thereof, configured to measure particulate matter to provide the sensor feedback.

17. A system comprising:
at least one inlet configured to convey a particulate fuel from a particulate fuel supply;
a corner-less chamber fluidly coupled to the at least one inlet;
at least one aerator disposed inside the corner-less chamber; and
at least one outlet fluidly coupled to the corner-less chamber and configured to convey a fluidized particulate fuel outwardly from the corner-less chamber, wherein the at least one aerator is configured to discharge a fluid into the corner-less chamber to fluidize the particulate fuel into the fluidized particulate fuel.

18. The system of claim 17, wherein the fuel comprises a particulate matter and the fluidized fuel comprises the particulate matter having a minimum fluidization velocity.

19. The system of claim 17, wherein the fluid comprises a gas.

20. The system of claim 19, wherein the gas comprises air.
